(19) United States
(12) Patent Application Publication
(10) Pub. No.: US 2024/0370350 A1
(43) Pub. Date: Nov. 7, 2024

(54) SYSTEMS AND METHODS FOR TWO-STAGE APPLICATION TESTING

(71) Applicant: Wells Fargo Bank, N.A., San Francisco, CA (US)

(72) Inventors: Ramesh Babu Sarvesetty, Bangalore (IN); Ananth Kendapadi, Charlotte, NC (US); Himanshu Baral, Fremont, CA (US); Ashutosh Verma, Bengaluru (IN)

(21) Appl. No.: 18/311,094

(22) Filed: May 2, 2023

(51) Int. Cl. G06F 11/36

(52) U.S. Cl. CPC G06F 11/3608

(57) ABSTRACT

Systems, apparatuses, methods, and computer program products are disclosed for two-stage application testing using generative artificial intelligence. An example method includes receiving, by communications hardware, an application and a first context setting and testing, by preliminary testing circuitry, the application using a preliminary testing model. The example method further includes generating, by advanced testing circuitry and using a scenario generation model, one or more first context-based testing scenarios based on the first context setting and testing, by the advanced testing circuitry, the application using an advanced testing model, where the advanced testing model uses the one or more first context-based testing scenarios.

### BACKGROUND

Application testing is an important and necessary step in application development to ensure software is delivered with the highest possible code quality. Complex software applications, including systems of many individual software services, may operate in such complex environments and with such large spaces of potential input data, that testing all possible use cases may be prohibitively costly.

### BRIEF SUMMARY

Application testing is necessary for development of bug-free, robust software ready for deployment in the real world. Currently, manual testing and automation testing are the two main types of application testing used. Manual testing requires operators, such as software engineers, to develop tests for the application and manually identify faults. In contrast, automated testing uses automation testing tools to generate tests for the application and automatically identify faults. Application testing may consider various scales of computer applications, from individual functions up to large systems of interconnected applications and services. Application testing may also be static, analyzing static code, dynamic, analyzing compiled programs, or contain elements of both.

Conventional automation testing tools are often generic and do not consider business contextual parameters or needs. As such, these automation tools may fail to generate tests for the application which involve business-specific scenarios that may occur during use. As such, there is a need to develop solutions that incorporate these contextual-specific scenarios into application testing. Additionally, the time and cost required to test applications expands with the complexity of the application, and it may become virtually impossible to execute every conceivable test for a particular application. Accordingly, methods are used to select tests that are most likely to reflect cases actually encountered in the application's regular use. The application's regular use may depend on context-related factors such as the computing platform, intended users, business use, and other factors. However, generating a sample of tests that is both sufficiently large to cover all possible important use cases and tailored specifically to the intended use of the application presents a challenge for developers.

In contrast to these conventional techniques for application testing, example embodiments described herein use a two-stage testing model that uses generative artificial intelligence (GAI) to generate application tests for a particular application context. Example embodiments may rapidly generate sufficiently large numbers of tests to cover important use cases that are relevant to the operation of a particular application. By training the GAI with test cases that are similar to the context of the application's intended use, the generated tests also represent a sample that is focused on the most important test cases to run. This similarity to the important test cases improves the efficiency of the application testing.

Accordingly, the present disclosure sets forth systems, methods, and apparatuses that advance the technical field of application testing. Example embodiments enable more effective, and cheaper testing of applications leading to faster application development and fewer software bugs in released products. Furthermore, by using transfer learning, example embodiments may develop a battery of tests within a given context with a smaller training dataset of previous application tests. The two-stage design of some example embodiments disclosed herein also ensures that resources used in executing context-specific application tests are used efficiently and not wasted on more trivial, general domain problems.

In one example embodiment, the techniques described herein relate to a method including: receiving, by communications hardware, an application and a first context setting; testing, by preliminary testing circuitry, the application using a preliminary testing model; generating, by advanced testing circuitry and using a scenario generation model, one or more first context-based testing scenarios based on the first context setting; and testing, by the advanced testing circuitry, the application using an advanced testing model, wherein the advanced testing model uses the one or more first context-based testing scenarios.

In another example embodiment, the techniques described herein relate to an apparatus including communications hardware configured to receive an application and a first context setting; preliminary testing circuitry configured to test the application using a preliminary testing model; and advanced testing circuitry configured to generate, using a scenario generation model, one or more first context-based testing scenarios based on the first context setting, and test the application using an advanced testing model, wherein the advanced testing model uses the one or more first context-based testing scenarios.

In another example embodiment, the techniques described herein relate to an apparatus including means for receiving an application and a first context setting; means for testing the application using a preliminary testing model; means for generating, using a scenario generation model, one or more first context-based testing scenarios based on the first context setting; and means for testing the application using an advanced testing model, wherein the advanced testing model uses the one or more first context-based testing scenarios.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for two-stage testing of an application.

FIG. 2 illustrates a schematic block diagram of example circuitry embodying a device that may perform various operations in accordance with some example embodiments described herein.

FIG. 3 illustrates an example flowchart for using a scenario generation model to generate context-based testing scenario based on a first context parameter, in accordance with some example embodiments described herein.

FIG. 4 illustrates an example flowchart for training a scenario generation model using transfer learning, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “application” may refer to a computer program configured to perform a particular task or tasks. The application may exist as compiled (e.g., able to be executed by a processor 202) program or uncompiled software code. In some embodiments, the application may be firmware, either executed on physical hardware or emulated, for example, using a virtual machine. The application may be an incomplete computer program, in an instance where the application is under development, or may be a complete computer program.

The term “context setting” may refer to a data construct configured to describe the particular context in which the application may operate, for example a business department (e.g., marketing, accounting, information technology), a platform (e.g., cloud deployment, on-site deployment, mobile devices), an operating system, a business field (e.g., finance, technology, energy, etc.), or the like. The context setting may be related to one or more context-based testing scenario datasets. The context setting may describe a context parameter related to the context in which the application may operate, for example, the context setting may include probability distributions for various types of customer or user interactions, risk profiles for various cybersecurity threats, profiles of hardware or platform technology typically used in the context, or other similar data.

The term “context-based testing scenario” may refer to scenario data associated with a particular context parameter and its related context setting. The context-based scenario may include scenarios, such as series of input data to provide to an application, where the series of input data reflects what is typically found in the context of the associated context parameter. The context-based testing scenario data may be a data construct configured to be read by application testing frameworks, such as the preliminary testing model or the advanced testing model, described below. The context-based testing scenario data may also be configured to be read by trainable machine learning models, such as a scenario generation model, described below. The context-based testing scenario data may be specific to a certain application, or, in some embodiments, may be general scenario data that may be used to test a variety of applications. Context-based testing scenario data may be generated, for example, by the scenario generation model, or may be collected by other means.

The term “circumstantial data” may refer to data that indicates the context in which an application typically operates. The circumstantial data may be data collected by the application, or may be collected by a different process, such as a utility application that collects circumstantial data about the application. In some embodiments, the circumstantial data may include a use case. The use case may be provided, for example, by a user when configuring an example apparatus. Additionally or alternatively, the use case may be specified by a developer of the application, using application metadata or the like. In some embodiments, one or more application discovery tools may infer the use case of the application to generate the circumstantial data. For example, an application may be installed with a manifest or configuration file that specifies settings for a cloud deployment. The configuration file may be circumstantial data that indicates the application may operate in the context of a cloud-based platform. For another example, text data may be harvested from an application and processed for keywords that may indicate an industry or business field (e.g., finance, technology, energy), which may be circumstantial data that indicates the business field in which the application operates.

The term “preliminary testing model” may refer to a software testing application or framework configured to analyze the application. The preliminary testing model may analyze the application by reviewing the code base for errors or inconsistencies, test inputs and outputs of the application in certain scenarios, test for compatibility with other applications or components, or perform any of a number of software tests of the like. The preliminary testing model may test at any level of the application, including unit testing at the level of individual functions or small discrete units, up to large-scale system testing. The preliminary testing model may be static, primarily analyzing the application code, and/or the preliminary testing model may be dynamic, involving execution of the compiled application. In some embodiments, the application may be compiled in a special configuration for testing, such as compiling with debug flags or other symbols that enable interfacing with the preliminary testing model. The preliminary testing model may be a complete application product provided by a vendor, or may be a custom-designed model for testing the application.

The term “service component” may refer to a data construct configured to describe a discrete element of an application. An application service component may be associated with an application service component type. Application service component types may include an application code snippet, an application function, an application programming interface (API) element, a sub-application, a complete application, and/or the like. Each application service component may refer to a discrete element of the application and may range in size from an individual code snippet of an application up to the entire application itself. In some embodiments, an application service component may be separated from other application service components and tested as an individual unit. An application service component may be determined using application inventory data, which may be received from one or more application discovery tools.

The term “scenario generation model” may refer to a data construct that is configured to describe parameters, hyper-parameters, and/or stored operations of a model to process a set of context-based testing scenario data to generate context-based testing scenarios. In some embodiments, the scenario generation model is a trained machine learning model. In particular, the scenario generation model may be a neural network (e.g., feedforward artificial neural network (ANN), multilayer perceptron (MLP), attention-based models, etc.) and/or a classification machine learning model (e.g., random forest, etc.). The scenario generation model may be trained based at least in part on context-based testing scenario data based on the context parameter used. Alternatively, the scenario generation model may be a rules-based model configured to follow a defined set of rules and/or operations to generate context-based testing scenarios. In some embodiments, the scenario generation model may be a hybrid model which uses both machine learning model techniques and rules-based model techniques. For example, the scenario generation model may be configured to evaluate whether given context-based testing scenario data is compatible with rules or requirements by a particular embodiment. If the scenario generation model identifies one or more incompatibilities or inferred mismatches between given context-based testing scenario data and a requirement for the embodiment, the scenario generation model may generate context-based testing scenarios that address the mismatch between the current configuration and the required configuration as required by the embodiment, either via machine learning techniques or via a rules-based model.

In some embodiments, the scenario generation model may be a neural network. In some embodiments, the scenario generation model may be any generative machine learning model, including a generative adversarial network. In an instance in which an example apparatus is configured so that one of the models is a neural network, the hyperparameters of the neural network, such as the number of layers, number of nodes per layer, activation functions, and other hyperparameters of the neural network may be configured. In some embodiments, the scenario generation model may be part of a generative adversarial network that also includes an objective function. The objective function may be based on a difference between the generated context-based testing scenarios and the context-based testing scenario data. The objective function may depend on the similarity of the generated context-based testing scenario to the context-based testing scenario data.

The term “advanced testing model” may refer to a software testing application or framework configured to analyze the application. The advanced testing model may analyze the application by reviewing the code base for errors or inconsistencies, test inputs and outputs of the application in certain scenarios, test for compatibility with other applications or components, or perform any of a number of software tests of the like. The advanced testing model may test at any level of the application, including unit testing at the level of individual functions or small discrete units, up to large-scale system testing. The advanced testing model may be static, primarily analyzing the application code, and/or the advanced testing model may be dynamic, involving execution of the compiled application. In some embodiments, the application may be compiled in a special configuration for testing, such as compiling with debug flags or other symbols that enable interfacing with the advanced testing model. The advanced testing model may be configured to test based on one or more supplied context-based testing scenarios, and the behavior of the advanced testing model may vary based on the context-based testing scenarios provided.

### System Architecture

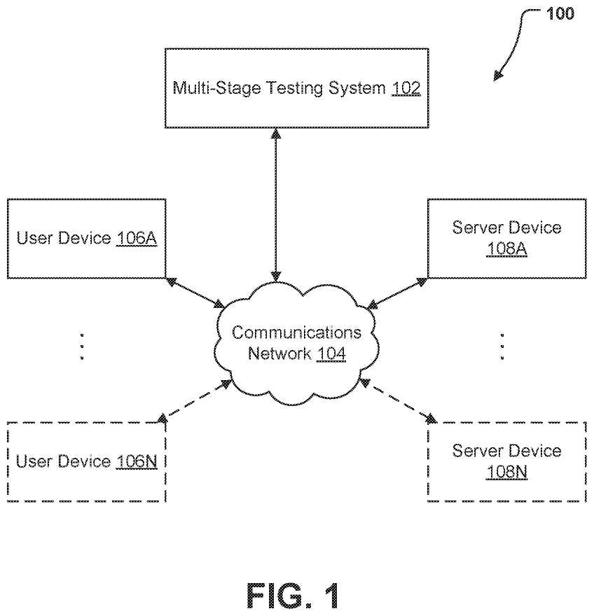

Example embodiments described herein may be implemented using any of a variety of computing devices or servers. To this end, FIG. 1 illustrates an example environment 100 within which various embodiments may operate. As illustrated, a two-stage testing system 102 may receive and/or transmit information via communications network 104 (e.g., the Internet) with any number of other devices, such as one or more of user devices 106A-106N and/or server devices 108A-108N.

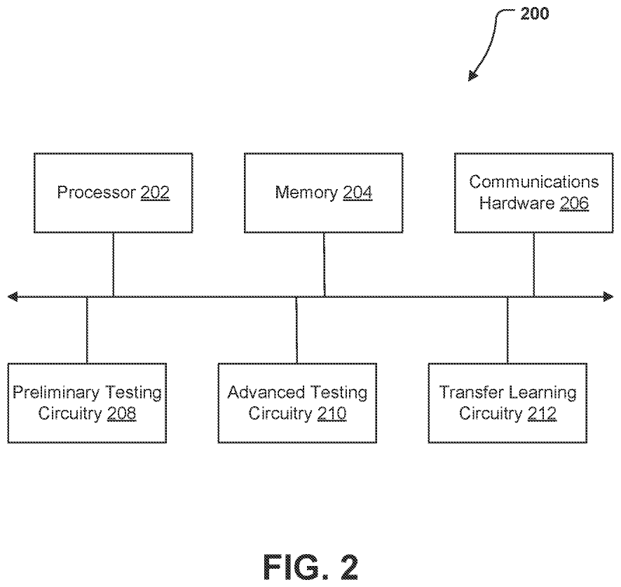

The two-stage testing system 102 may be implemented as one or more computing devices or servers, which may be composed of a series of components. Particular components of the two-stage testing system 102 are described in greater detail below with reference to apparatus 200 in connection with FIG. 2.

The one or more user devices 106A-106N and the one or more server devices 108A-108N may be embodied by any computing devices known in the art. The one or more user devices 106A-106N and the one or more server devices 108A-108N need not themselves be independent devices, but may be peripheral devices communicatively coupled to other computing devices.

### Example Implementing Apparatuses

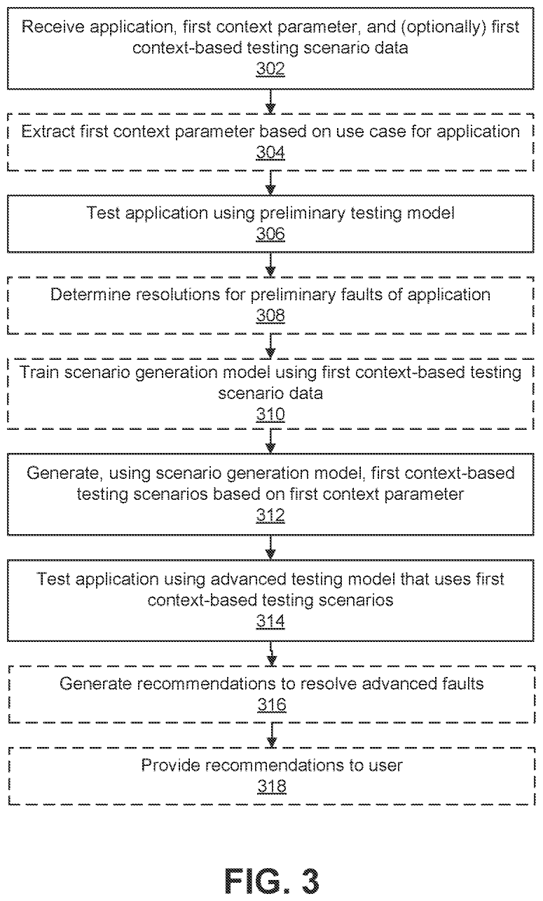

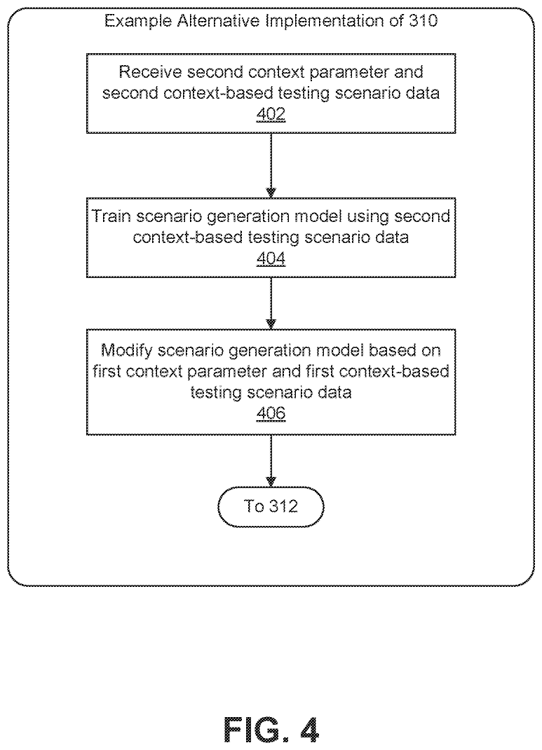

The two-stage testing system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-4. As illustrated in FIG. 2, the apparatus 200 may include processor 202, memory 204, communications hardware 206, preliminary testing circuitry 208, advanced testing circuitry 210, and transfer learning circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a preliminary testing circuitry 208 that tests applications using a preliminary testing model and optionally determines resolutions for preliminary faults of the application. The preliminary testing circuitry 208 may utilize processor 202, memory 204, or any other hardware component included in the apparatus 200 to perform these operations, as described in connection with FIGS. 3-4 below. The preliminary testing circuitry 208 may further utilize communications hardware 206 to gather data from a variety of sources (e.g., user devices 106A-106N as shown in FIG. 1), and/or exchange data with a user, and in some embodiments may utilize processor 202 and/or memory 204 to perform preliminary testing of the application.

In addition, the apparatus 200 further comprises an advanced testing circuitry 210 that trains a scenario generation model, generates context-based testing scenarios, and tests an application using the generated scenarios. The advanced testing circuitry 210 may utilize processor 202, memory 204, or any other hardware component included in the apparatus 200 to perform these operations, as described in connection with FIGS. 3-4 below. The advanced testing circuitry 210 may further utilize communications hardware 206 to gather data from a variety of sources (e.g., user devices 106A-106N, or server devices 108A-108N as shown in FIG. 1), and/or exchange data with a user, and in some embodiments may utilize processor 202 and/or memory 204 to test the application.

Further, the apparatus 200 further comprises a transfer learning circuitry 212 that modifies a scenario generation model trained in a first context to generate context-based testing scenarios in a second context. The transfer learning circuitry 212 may utilize processor 202, memory 204, or any other hardware component included in the apparatus 200 to perform these operations, as described in connection with FIGS. 3-4 below. The transfer learning circuitry 212 may further utilize communications hardware 206 to gather data from a variety of sources (e.g., user devices 106A-106N or server devices 108A-108N, as shown in FIG. 1), and/or exchange data with a user, and in some embodiments may utilize processor 202 and/or memory 204 to modify the scenario generation model.

Although components 202-212 are described in part using functional language, it will be understood that the particular implementations necessarily include the use of particular hardware. It should also be understood that certain of these components 202-212 may include similar or common hardware. For example, the preliminary testing circuitry 208, advanced testing circuitry 210, and transfer learning circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the preliminary testing circuitry 208, advanced testing circuitry 210, and transfer learning circuitry 212 may leverage processor 202, memory 204, or communications hardware 206 as described above, it will be understood that any of preliminary testing circuitry 208, advanced testing circuitry 210, and transfer learning circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that preliminary testing circuitry 208, advanced testing circuitry 210, and transfer learning circuitry 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3 and 4, example flowcharts are illustrated that contain example operations implemented by example embodiments described herein. The operations illustrated in FIGS. 3 and 4 may, for example, be performed by the two-stage testing system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, preliminary testing circuitry 208, advanced testing circuitry 210, transfer learning circuitry 212 and/or any combination thereof. It will be understood that user interaction with the two-stage testing system 102 may occur directly via communications hardware 206, or may instead be facilitated by a separate user device (e.g., one of user devices 106A-106N), as shown in FIG. 1, and which may have similar or equivalent physical componentry facilitating such user interaction.

Turning first to FIG. 3, example operations are shown for using a scenario generation model to generate context-based testing scenario based on a first context parameter. As shown by operation 302, the apparatus 200 includes means, such as processor 202, memory 204, communications hardware 206, or the like, for receiving an application and a first context setting. The application may be a computer program configured to perform a particular task or tasks. The application may exist as compiled (e.g., able to be executed by a processor 202) program or uncompiled software code. In some embodiments, the application may be firmware, either executed on physical hardware or emulated, for example, using a virtual machine. The application may be an incomplete computer program, in an instance where the application is under development, or may be a complete computer program.

The first context setting may be a data construct configured to describe the particular context in which the application may operate, for example a business department (e.g., marketing, accounting, information technology), a platform (e.g., cloud deployment, on-site deployment, mobile devices), an operating system, a business field (e.g., finance, technology, energy, etc.), or the like. The first context setting may be related to one or more context-based testing scenario datasets. The context setting may describe a context parameter related to the context in which the application may operate, for example, the context setting may include probability distributions for various types of customer or user interactions, risk profiles for various cybersecurity threats, profiles of hardware or platform technology typically used in the context, or other similar data.

In some embodiments, the apparatus 200 may further receive first context-based testing scenario data. The first context-based testing scenario data may be scenario data associated with a particular context parameter. The context-based scenario may include scenarios, such as series of input data to provide to an application, where the series of input data reflects what is typically found in the context of the associated context parameter. The context-based testing scenario data may be a data construct configured to be read by application testing frameworks, such as the preliminary testing model or the advanced testing model, described below. The context-based testing scenario data may also be configured to be read by trainable machine learning models, such as the scenario generation model, described below. The context-based testing scenario data may be specific to a certain application, or, in some embodiments, may be general scenario data that may be used to test a variety of applications.

The apparatus 200 may receive the application, the first context parameter, and/or the first context-based testing scenario data via the communications network 104 by means of network hardware of the communications hardware 206. Additionally or alternatively, the apparatus 200 may retrieve the application, the first context parameter, and/or the first context-based testing scenario data from external devices such as a user device 106A through 106N and/or a server device 108A through 108N. In some embodiments, the application, the first context parameter, and/or the first context-based testing scenario data may be stored local to the apparatus 200 and may be retrieved using the memory 204. Regardless of how the application, the first context parameter, and/or the first context-based testing scenario data are retrieved, they may become accessible to the various circuitry of the apparatus 200, including the processor 202, preliminary testing circuitry 208, and advanced testing circuitry 210, and may be stored in whole or in part locally using volatile or non-volatile memory 204.

As shown by operation 304, the apparatus 200 may include means, such as processor 202, memory 204, communications hardware 206, advanced testing circuitry 210, or the like, for extracting the first context setting based on circumstantial data associated with the application. The circumstantial data may be data that indicates the context in which an application typically operates. The circumstantial data may be data collected by the application, or may be collected by a different process, such as a utility application that collects circumstantial data about the application. In some embodiments, the circumstantial data may include a use case. The use case may be provided, for example, by a user when configuring the two-stage testing system 102, or may be specified by a developer of the application, such as by using application metadata or the like. In some embodiments, one or more application discovery tools may infer the use case of the application to generate the circumstantial data.

The advanced testing circuitry 210 may extract the first context setting based on the circumstantial data by processing the circumstantial data, for example, by a lookup table or other rules-based procedure for determining the first context setting. In some embodiments, the advanced testing circuitry 210 may use a machine learning algorithm to determine the first context setting, and may be trained on a dataset of historical circumstantial data for applications.

As shown by operation 306, the apparatus 200 includes means, such as processor 202, memory 204, communications hardware 206, preliminary testing circuitry 208, or the like, for testing the application using a preliminary testing model. The preliminary testing model may be a software testing application or framework configured to analyze the application. The preliminary testing model may analyze the application by reviewing the code base for errors or inconsistencies, test inputs and outputs of the application in certain scenarios, test for compatibility with other applications or components, or perform any of a number of software tests of the like. The preliminary testing model may test at any level of the application, including unit testing at the level of individual functions or small discrete units, up to large-scale system testing. The preliminary testing model may be static, primarily analyzing the application code, and/or the preliminary testing model may be dynamic, involving execution of the compiled application. In some embodiments, the application may be compiled in a special configuration for testing, such as compiling with debug flags or other symbols that enable interfacing with the preliminary testing model. The preliminary testing model may be a complete application product provided by a vendor, or may be a custom-designed model for testing the application.

In some embodiments, the application includes one or more service components. In some embodiments, testing the application using the preliminary testing model includes testing the one or more service components. The application service component may be a data construct configured to describe a discrete element of an application. An application service component may be associated with an application service component type. Application service component types may include an application code snippet, an application function, an application programming interface (API) element, a sub-application, a complete application, and/or the like. Each application service component may refer to a discrete element of the application and may range in size from an individual code snippet of an application up to the entire application itself. In some embodiments, an application service component may be separated from other application service components and tested as an individual unit. An application service component may be determined using application inventory data, which may be received from one or more application discovery tools.

In some embodiments, testing the application using the preliminary testing model may determine one or more preliminary faults of the application. The preliminary faults may be faults that are determined by the preliminary testing model. The preliminary faults may include error or inconsistencies in static code, unexpected or undefined behavior of the application under certain conditions, or the like. Preliminary faults may be conveyed using a data structure readable by certain components of the apparatus 200, may be a human-readable report, or may provide data through an API for other applications to interpret.

The preliminary testing circuitry 208 may use the preliminary testing model to test the application, in some embodiments, producing one or more preliminary faults of the application. The preliminary testing circuitry 208 may access the application stored in memory 204 or other storage, or may receive the application by communications hardware 206, either via a network interface from a remote host, or by any other attached hardware of the communications hardware 206. In some embodiments, the application may be stored on storage of a remote host, such as one of the server devices 108A through 108N. The preliminary testing circuitry 208 may analyze the application as described above and determine that no preliminary faults are present in the application, or in some embodiments, the preliminary testing circuitry 208 may determine that one or more preliminary faults are present.

In some embodiments, the preliminary testing stage may not be necessary. For example, the two-stage testing system 102 may skip the preliminary testing described above in connection with operation 306 and proceed directly to the advanced testing stage, including operation 310 through operation 318.

As shown by operation 308, the apparatus 200 may include means, such as processor 202, memory 204, communications hardware 206, preliminary testing circuitry 208, or the like, for determining one or more resolutions for the one or more preliminary faults of the application. As described above in connection with operation 306, in some embodiments the preliminary testing circuitry 208 may detect one or more preliminary faults of the application. In an instance in which the preliminary testing circuitry 208 detects one or more preliminary faults of the application, the preliminary testing circuitry 208 may be further configured to determine resolutions for the preliminary faults. For example, the preliminary testing circuitry 208 may determine through static testing that a line of code may produce undefined behavior, or behavior that may vary depending on the platform in ways that are difficult to predict. The preliminary testing circuitry 208 may provide a resolution by suggesting a change to the line of code containing the preliminary fault, for example, by changing the data type of a variable, using a smart pointer instead of a normal pointer, or the like. The resolution for the preliminary fault may be saved and stored to memory 204, or may be conveyed to a user via preliminary testing circuitry 208.

As shown by operation 310, the apparatus 200 may include means, such as processor 202, memory 204, communications hardware 206, advanced testing circuitry 210, or the like, for training the scenario generation model using the first context-based testing scenario data. The advanced testing circuitry 210 may train the scenario generation model by fitting the internal parameters of the scenario generation model to the inputs of the first context-based testing scenario data. The scenario generation model may be a data construct that is configured to describe parameters, hyper-parameters, and/or stored operations of a model to process a set of context-based testing scenario data to generate context-based testing scenarios. In some embodiments, the scenario generation model is a trained machine learning model. In particular, the scenario generation model may be a neural network (e.g., feedforward artificial neural network (ANN), multilayer perceptron (MLP), attention-based models, etc.) and/or a classification machine learning model (e.g., random forest, etc.). The scenario generation model may be trained based at least in part on context-based testing scenario data based on the context parameter used. Alternatively, the scenario generation model may be a rules-based model configured to follow a defined set of rules and/or operations to generate context-based testing scenarios. In some embodiments, the scenario generation model may be a hybrid model which uses both machine learning model techniques and rules-based model techniques. For example, the scenario generation model may be configured to evaluate whether given context-based testing scenario data is compatible with rules or requirements by a particular embodiment. If the scenario generation model identifies one or more incompatibilities or inferred mismatches between given context-based testing scenario data and a requirement for the embodiment, the scenario generation model may generate context-based testing scenarios that address the mismatch between the current configuration and the required configuration as required by the embodiment, either via machine learning techniques or via a rules-based model.

In some embodiments, the scenario generation model may be a neural network. In some embodiments, the scenario generation model may be any generative machine learning model, including a generative adversarial network. In an instance in which the two-stage testing system 102 is configured so that one of the models is a neural network, the hyperparameters of the neural network, such as the number of layers, number of nodes per layer, activation functions, and other hyperparameters of the neural network may be configured. In some embodiments, the scenario generation model may be part of a generative adversarial network that also includes an objective function. The objective function may be based on a difference between the generated context-based testing scenarios and the context-based testing scenario data. The objective function may depend on the similarity of the generated context-based testing scenario to the context-based testing scenario data.

In some embodiments, the advanced testing circuitry 210 may clean, format, infill, or otherwise prepare the first context-based testing scenario data for training. The advanced testing circuitry 210 may be configured to train the scenario generation model using supervised and/or unsupervised learning, may use a hybrid of both approaches, or may use training approaches with reduced levels of user supervision. The advanced testing circuitry 210 may use the entire dataset of the first context-based testing scenario data, or may be configured to divide the data for providing diagnostics, to control for overtraining, or for other reasons. In some embodiments, the scenarios of the first context-based testing scenario data may be interpreted and formatted as testing scenarios readable by the advanced testing circuitry 210 for testing an application. The advanced testing circuitry 210 may use the first context-based scenario received in connection with operation 302, described previously.

As shown by operation 312, the apparatus 200 includes means, such as processor 202, memory 204, communications hardware 206, advanced testing circuitry 210, transfer learning circuitry 212, or the like, for generating, using a scenario generation model, one or more first context-based testing scenarios based on the first context setting. The advanced testing circuitry 210 may use the trained model, which may be trained as shown in connection with operation 310, to generate the one or more context-based testing scenarios. The advanced testing circuitry 210 may generate the context-based testing scenario by providing a random or pseudo-random seed to the scenario generation model, which may be drawn from a pre-determined probability distribution. The scenario generation model may map the randomized input into a particular context-based testing scenario based on the training of the scenario generation model.

As shown by operation 314, the apparatus 200 includes means, such as processor 202, memory 204, communications hardware 206, advanced testing circuitry 210, or the like, for testing the application using an advanced testing model, where the advanced testing model uses the one or more first context-based testing scenarios. The advanced testing model may be a software testing application or framework configured to analyze the application. The advanced testing model may analyze the application by reviewing the code base for errors or inconsistencies, test inputs and outputs of the application in certain scenarios, test for compatibility with other applications or components, or perform any of a number of software tests of the like. The advanced testing model may test at any level of the application, including unit testing at the level of individual functions or small discrete units, up to large-scale system testing. The advanced testing model may be static, primarily analyzing the application code, and/or the advanced testing model may be dynamic, involving execution of the compiled application. In some embodiments, the application may be compiled in a special configuration for testing, such as compiling with debug flags or other symbols that enable interfacing with the advanced testing model. The advanced testing model may be configured to test based on one or more supplied context-based testing scenarios, and the behavior of the advanced testing model may vary based on the context-based testing scenarios provided. The one or more context-based testing scenarios may be generated previously, for example, during operation 312, and may be read by the advanced testing circuitry 210 for use with the advanced testing model.

In some embodiments, testing the application using the advanced testing model may determine one or more advanced faults of the application, and the one or more advanced faults may be related to the first context setting. The advanced faults may be faults that are determined by the advanced testing model associated with the first context setting and/or the first context parameter. The advanced faults may include error or inconsistencies in static code, unexpected or undefined behavior of the application under certain conditions, or the like. Advanced faults may be conveyed using a data structure readable by certain components of the apparatus 200, may be a human-readable report, or may provide data through an API for other applications to interpret.

As shown by operation 316, the apparatus 200 may include means, such as processor 202, memory 204, communications hardware 206, advanced testing circuitry 210, or the like, for generating one or more recommendations to resolve the one or more advanced faults. As described above in connection with operation 314, in some embodiments the advanced testing circuitry 210 may detect one or more advanced faults of the application. In an instance in which the advanced testing circuitry 210 detects one or more advanced faults of the application, the advanced testing circuitry 210 may be further configured to determine recommendations for resolving the advanced faults. For example, the advanced testing circuitry 210 may determine through static testing that a line of code may produce undefined behavior within a certain context setting. The advanced testing circuitry 210 may provide a recommended resolution by suggesting a change to the line of code containing the preliminary fault, for example, by changing the data type of a variable, using a smart pointer instead of a normal pointer, or the like. The recommended resolution for the advanced fault may be saved and stored to memory 204, or may be conveyed to a user via advanced testing circuitry 210.

As shown by operation 318, the apparatus 200 may include means, such as processor 202, memory 204, communications hardware 206, or the like, for providing the one or more recommendations to a user. The recommendations may be received during operation 316 when the advanced testing circuitry 210 generates one or more recommendations to resolve the one or more advanced faults. In some embodiments, the one or more recommendations may be provided via the communications hardware 206, either through attached input/output devices, or by transmitting the one or more recommendations by network hardware to a user, for example, on one of user device 106A through 106N.

Turning next to FIG. 4, example operations are shown for training a scenario generation model using transfer learning. As shown by operation 402, the apparatus 200 includes means, such as processor 202, memory 204, communications hardware 206 or the like, for receiving a second context setting, and second context-based testing scenario data. The apparatus 200 may also receive first context-based testing scenario data. The apparatus 200 may receive the second context setting, second context-based testing scenario data, and/or the first context-based testing scenario data via the communications network 104 by means of network hardware of the communications hardware 206. Additionally or alternatively, the apparatus 200 may retrieve the second context setting, second context-based testing scenario data, and/or the first context-based testing scenario data from external devices such as a user device 106A through 106N and/or a server device 108A through 108N. In some embodiments, the application, the second context setting, second context-based testing scenario data, and/or the first context-based testing scenario data may be stored local to the apparatus 200 and may be retrieved using the memory 204. Regardless of how the second context setting, second context-based testing scenario data, and/or the first context-based testing scenario data are retrieved, they may become accessible to the various circuitry of the apparatus 200, including the processor 202, preliminary testing circuitry 208, and advanced testing circuitry 210, and may be stored in whole or in part locally using volatile or non-volatile memory 204.

As shown by operation 404, the apparatus 200 includes means, such as processor 202, memory 204, communications hardware 206, advanced testing circuitry 210, or the like, for training the scenario generation model using the second context-based testing scenario data. The advanced testing circuitry 210 may train the scenario generation model by fitting the internal parameters of the scenario generation model to the inputs of the second context-based testing scenario data. In some embodiments, the advanced testing circuitry 210 may clean, format, infill, or otherwise prepare the second context-based testing scenario data for training. The advanced testing circuitry 210 may be configured to train the scenario generation model using supervised and/or unsupervised learning, may use a hybrid of both approaches, or may use training approaches with reduced levels of user supervision. The advanced testing circuitry 210 may use the entire dataset of the second context-based testing scenario data, or may be configured to divide the data for providing diagnostics, to control for overtraining, or for other reasons. In some embodiments, the scenarios of the second context-based testing scenario data may be interpreted and formatted as testing scenarios readable by the advanced testing circuitry 210 for testing an application. The advanced testing circuitry 210 may use the second context-based scenario received in connection with operation 402, described previously.

As shown by operation 406, the apparatus 200 includes means, such as processor 202, memory 204, communications hardware 206, transfer learning circuitry 212, or the like, for modifying the scenario generation model based on the first context setting and the first context-based testing scenario data. The modified scenario generation model may generate the one or more first context-based testing scenarios based on the first context setting and the second context setting. For example, the scenario generation model may be trained using the first context setting and the first context-based testing scenario data. The transfer learning circuitry 212 may then fix a subset of the model parameters of the scenario generation model, while allowing other parameters to be changed. The transfer learning circuitry 212 may then train the scenario generation model using the second context setting and second context-based testing scenario data. In this example, the parameters of the scenario generation model may then depend on both the first context-based testing scenario data and the second context-based testing scenario data. By way of continued example, in an instance in which the scenario generation model is a neural network with multiple hidden layers, a number of the first layers of the neural network may be fixed after training with the first context-based testing scenario data. Subsequently, the remaining, later layers may be re-trained using the second context-based testing scenario data, using a transfer learning technique. In this example, the scenario generation model may be trained to produce context-based testing scenarios related to the second context parameter even in a case where limited samples of the second context-based testing scenario data are available.

It will be understood that while a preliminary stage and an advanced stage are described above in connection with the two-stage testing system 102, in some embodiments, additional stages may be present. Additional stages may exist prior to the preliminary stage, between the preliminary and advanced stage, or after the testing stage. In some embodiments, additional stages may be one or more repetitions of the preliminary or advanced stages. The repetitions of the advanced and/or preliminary stages may have different configurations, for example, an example embodiment may have two preliminary stages which use two different vendor-provided preliminary testing platforms. In some embodiments, additional stages may cause execution of further third-party tools or processes that may augment or extend the processes disclosed herein.

FIGS. 3 and 4 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 3 and 4 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved application testing using a two-stage testing framework with GAI. By leveraging GAI to construct testing scenarios aimed at a particular application context, example embodiments avoid the difficulty traditionally experienced in general application testing without a specific context. Finally, by automatically producing context-dependent testing scenarios, computing resources may be used more efficiently to test applications and deliver bug-free, high-quality products that reduce costs for developers.

As these examples all illustrate, example embodiments contemplated herein provide technical solutions that solve real-world problems faced during application testing. And while application testing has been an issue for decades, the steadily increasing complexity of business applications has made this problem significantly more acute, as the demand for complex applications has grown significantly even while the complexity of the applications themselves have increased. At the same time, the recently arising ubiquity of GAI has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, an application and a first context setting;
testing, by preliminary testing circuitry, the application using a preliminary testing model;
generating, by advanced testing circuitry and using a scenario generation model, one or more first context-based testing scenarios based on the first context setting; and
testing, by the advanced testing circuitry, the application using an advanced testing model, wherein the advanced testing model uses the one or more first context-based testing scenarios.

2. The method of claim 1, wherein testing the application using the preliminary testing model determines one or more preliminary faults of the application, wherein the method further comprises:
determining, by the preliminary testing circuitry, one or more resolutions for the one or more preliminary faults of the application.

3. The method of claim 1, wherein testing the application using the advanced testing model determines one or more advanced faults of the application, wherein the one or more advanced faults are related to the first context setting.

4. The method of claim 3, further comprising:
generating, by the advanced testing circuitry, one or more recommendations to resolve the one or more advanced faults; and
providing, by the communications hardware, the one or more recommendations to a user.

5. The method of claim 1, further comprising:
receiving, by the communications hardware, first context-based testing scenario data; and
training, by the advanced testing circuitry, the scenario generation model using the first context-based testing scenario data.

6. The method of claim 1, further comprising:
extracting, by the advanced testing circuitry, the first context setting based on circumstantial data associated with the application.

7. The method of claim 1, further comprising:
receiving, by communications hardware, a second context setting, first context-based testing scenario data, and second context-based testing scenario data;
training, by the advanced testing circuitry, the scenario generation model using the second context-based testing scenario data; and
modifying, by transfer learning circuitry, the scenario generation model based on the first context setting and the first context-based testing scenario data, wherein the modified scenario generation model generates the one or more first context-based testing scenarios based on the first context setting and the second context setting.

8. The method of claim 1, wherein (i) the application comprises one or more service components, and (ii) testing the application using the preliminary testing model comprises testing the one or more service components.

9. An apparatus comprising:
communications hardware configured to receive an application and a first context setting;
preliminary testing circuitry configured to test the application using a preliminary testing model; and
advanced testing circuitry configured to:
generate, using a scenario generation model, one or more first context-based testing scenarios based on the first context setting, and
test the application using an advanced testing model, wherein the advanced testing model uses the one or more first context-based testing scenarios.

10. The apparatus of claim 9, wherein testing the application using the preliminary testing model determines one or more preliminary faults of the application, wherein the preliminary testing circuitry is further configured to:
determine one or more resolutions for the one or more preliminary faults of the application.

11. The apparatus of claim 9, wherein testing the application using the advanced testing model determines one or more advanced faults of the application, wherein the one or more advanced faults are related to the first context setting.

12. The apparatus of claim 11:
wherein the advanced testing circuitry is further configured to generate one or more recommendations to resolve the one or more advanced faults;
wherein the communications hardware is further configured to provide the one or more recommendations to a user.

13. The apparatus of claim 9:
wherein the communications hardware is further configured to receive first context-based testing scenario data;
wherein the advanced testing circuitry is further configured to train the scenario generation model using the first context-based testing scenario data.

14. The apparatus of claim 9, wherein the advanced testing circuitry is further configured to:
extract the first context setting based on circumstantial data associated with the application.

15. The apparatus of claim 9:
wherein the communications hardware is further configured to receive a second context setting, first context-based testing scenario data, and second context-based testing scenario data;
wherein the advanced testing circuitry is further configured to train the scenario generation model using the second context-based testing scenario data; and
wherein the apparatus further comprises transfer learning circuitry configured to modify the scenario generation model based on the first context setting and the first context-based testing scenario data, wherein the modified scenario generation model generates the one or more first context-based testing scenarios based on the first context setting and the second context setting.

16. The apparatus of claim 9, wherein (i) the application comprises one or more service components, and (ii) testing the application using the preliminary testing model comprises testing the one or more service components.

17. An apparatus comprising:
means for receiving an application and a first context setting;
means for testing the application using a preliminary testing model;
means for generating, using a scenario generation model, one or more first context-based testing scenarios based on the first context setting; and
means for testing the application using an advanced testing model, wherein the advanced testing model uses the one or more first context-based testing scenarios.

18. The apparatus of claim 17, wherein testing the application using the preliminary testing model determines one or more preliminary faults of the application, wherein the apparatus further comprises:
means for determining one or more resolutions for the one or more preliminary faults of the application.

19. The apparatus of claim 17, wherein testing the application using the advanced testing model determines one or more advanced faults of the application, wherein the one or more advanced faults are related to the first context setting.

20. The apparatus of claim 19, further comprising:
means for generating one or more recommendations to resolve the one or more advanced faults; and
means for providing the one or more recommendations to a user.
